(19) United States
(12) Patent Application Publication
(10) Pub. No.: US 2022/0331791 A1
(43) Pub. Date: Oct. 20, 2022

(54) DROPPER

(71) Applicant: APC Packaging, LLC., Fort Lauderdale, FL (US)

(72) Inventor: Robert John BULLA, Coral Springs, FL (US)

(21) Appl. No.: 17/500,029

(22) Filed: Oct. 13, 2021

Related U.S. Application Data
(63) Continuation-in-part of application No. 17/233,222, filed on Apr. 16, 2021, now Pat. No. 11,148,131.

(51) Int. Cl. B01L 3/02; B65D 47/18

(52) U.S. Cl. CPC B01L 3/0217; B01L 3/0282; B65D 47/18

(57) ABSTRACT

A dropper includes a bulb, a pipette coupled to the bulb, and a cap coupled to the bulb. The dropper is composed entirely of recyclable material that complies with specifications of a same recycle code. In one embodiment, the bulb, the pipette and the cap each includes a cycle symbol for cycle code “5”. The dropper is recyclable as a single unit. In one embodiment, the pipette includes an undercut on an inside of the pipette nearest the bulb. In one embodiment, the dropper also includes a button and a collar, and the dropper is attached to a bottle such that depressing the button squeezes the bulb and causes the dropper to dispense contents of bottle. In one embodiment, the dropper includes a combined bulb and cap composed entirely of recyclable material that complies with recycle code of “5” specifications.

### CROSS REFERENCE TO RELATED APPLICATION

The present application is a continuation of U.S. patent application Ser. No. 17/233,222, filed Apr. 26, 2021, which is hereby fully incorporated by reference herein.

### BACKGROUND

### Field

This invention relates generally to droppers, and more specifically to a dropper that is recyclable.

### Related Art

Droppers, also known as Pasteur pipettes, are well known. A dropper is a device used to measure liquids by drops. Typically, a dropper consists of a bulb, a pipette and often a cap. Droppers having two or more of its components made of dissimilar materials are well known. Droppers having one or all of its components made of materials that are not recyclable are well known. Droppers made in whole or in part of plastic are well known.

Droppers with a pipette made of regular polypropylene (C₃H₆) or made of standard clarified polypropylene are well known. A pipette made of regular polypropylene (C₃H₆) is disadvantageously opaque such that an amount of liquid, or bulk, in the pipette cannot be readily discerned. A pipette made of standard clarified polypropylene is disadvantageous because its hazy milky appearance can skew color palettes in the beauty industry, and it has a low-quality appearance. Also, even if a pipette made of standard clarified polypropylene were separated from the rest of a dropper, the pipette would still not be recycled because the pipette would fail a minimum size requirement, a 2-inch by 2-inch test, promulgated by The Association of Plastic Recyclers of Washington, D.C., USA. Some recyclers may require that recyclable plastic material have minimum dimensions that are different from 2 inches by 2 inches.

Droppers with a bulb made of a thermoplastic elastomer, silicone or nitrile are well known. Disadvantageously, a bulb made of a thermoplastic elastomer, silicone or nitrile is not recyclable.

Droppers made in whole or in part of glass are well known. Droppers with a pipette made of glass are well known. Disadvantageously, a pipette made of glass can break or shatter easily. Disadvantageously, in many cases, a pipette made of glass is not recyclable because vial glass, also known as borosilicate glass, is not recycled and is it not easily discernible from flint glass. Borosilicate glass and flint glass will mix but the amount of heat required goes up significantly causing many issues when converting. A pipette made of glass must be shorter than a pipette made of plastic due to tolerances of glass cutting and forming. A pipette made of glass can shatter inside a bottle if the pipette were only slightly too long. Glass is fragile even when it is not in a bottle. Even if a pipette made of glass were separated from the rest of the dropper in an attempt to recycle the rest of the dropper, in most cases the rest of the dropper would still not be recycled because the bulb would fail the 2-inch by 2-inch test.

Droppers having some of their parts made of recyclable materials and some of their parts made of non-recyclable materials are well known. With such droppers, although it may be possible to separate the parts made of recyclable materials from the parts made of non-recyclable materials, the resulting parts (made of recyclable materials) would be too small to be recycled. This is because the recycling industry requires that at least one dimension of recyclable plastic material be at least 2 inches, and the largest dimension of individual parts of most droppers for the beauty, or cosmetic, industry is less than 2 inches.

One known dropper is made entirely of polypropylene. However, this known dropper disadvantageously has a bulb that is very stiff and is hard to squeeze. Moreover, this known dropper disadvantageously has a pipette that is very cloudy and hazy.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a front view of a dropper, including a bulb, a cap and a pipette, in accordance with the invention.

FIG. 2 is a top view of the dropper shown in FIG. 1.

FIG. 3 is a bottom view of the dropper shown in FIG. 1.

FIG. 4 is a cross-sectional view of the dropper shown in FIG. 1.

FIG. 5 is a front view of the pipette in accordance with the invention.

FIG. 6 is a cross-sectional view of the pipette shown in FIG. 5.

FIG. 7 is an enlargement of area “A” shown in FIG. 6.

FIG. 8 is a front view of a two-piece dropper in accordance with the invention including a combined bulb and cap, and a pipette.

FIG. 9 is a front view of the combined bulb and cap shown in FIG. 8.

FIG. 10 is a front view of a pipette shown in FIG. 8.

FIG. 11 is an exploded view of a push-button dropper in accordance with the invention.

FIG. 12 is a cross-sectional view of the push-button dropper of FIG. 11.

FIG. 13 is an exploded front view of a child resistant dropper in accordance with the invention.

FIG. 14 is a cross-sectional view of the child resistant dropper of FIG. 13.

FIG. 15 is an exploded front view of a tamper evident dropper in accordance with the invention.

FIG. 16 is a cross-sectional view of the tamper evident dropper of FIG. 15.

FIG. 17 is an exploded view of a child resistant-tamper evident dropper in accordance with the invention.

FIG. 18 is a cross-sectional view of the child resistant-tamper evident dropper of FIG. 17.

FIG. 19 is a perspective view of part of the dropper of FIG. 1 showing a recycle code symbol on the bulb.

FIG. 20 is a perspective view of the pipette of FIG. 1 showing a recycle code symbol on the pipette.

FIG. 21 shows detail of area “A” in FIG. 20.

FIG. 22 is a perspective view of the cap of FIG. 1 showing a recycle code symbol on the cap.

FIG. 23 shows detail of area “A” in FIG. 22.

FIG. 24 is a perspective view a bottle which may be used with the dropper of FIG. 1 and which shows a recycle code symbol on the bottle.

### DETAILED DESCRIPTION

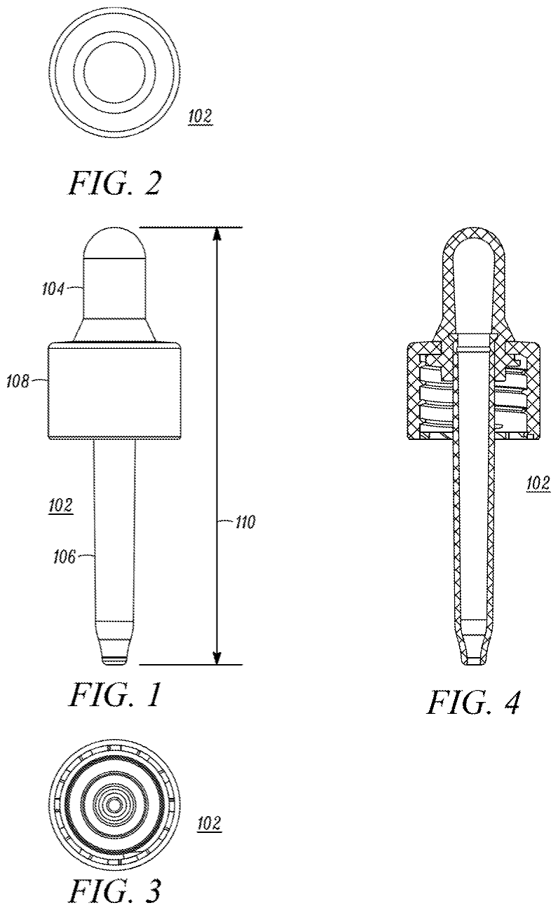

FIG. 1 is a front view of a dropper 102 in accordance with the invention. The dropper 102 comprises a bulb 104, a pipette 106 coupled to the bulb, and a cap 108 coupled to the bulb. Although a size of the bulb 104, the pipette 106 and the cap 108 may be less than 2 inches individually, the dropper 102 advantageously has a length 110 of at least 2 inches. Therefore, the dropper 102 meets the minimum-size requirement for recyclability. The dropper 102 is recyclable as a unit, i.e., the dropper can be recycled without first being disassembled. In one embodiment, the cap 108 holds the bulb 104 and attaches to a container or bottle 2400 (see FIG. 24) in a manner well known. The bottle 2400 may hold a liquid, or bulk, that can be pulled into the pipette 106 and dispensed from the pipette through use of the dropper 102 in a manner well known.

In one embodiment, the bulb 104 is made of polyolefins with alternating blocks of hard and soft segments manufactured by The Dow Chemical Company of Midland, Mich. and marketed under the tradename INFUSE™ olefin block copolymer by The Dow Chemical Company. Advantageously, this material has good creep resistance, has better compression set properties than polypropylene, and complies with specifications of resin identification code, or recycle code, “5” according to ASTM D7611, entitled Standard Practice for Coding Plastic Manufactured Articles for Resin Identification, promulgated by ASTM International of West Conshohocken, Pa., USA. In one embodiment, the bulb 104 is made of INFUSE™ olefin block copolymer grade 9507. Other olefins, used with known droppers, have varying degrees of flexibility but fail with compression set and creep of the dimensions.

In another embodiment, the bulb 104 is made of an ethylene-propylene copolymer (CAS No: 90110-79-1), chemical formula C₅H₁₀, one version of which is marketed under the tradename Vistamaxx™ by ExxonMobil Chemical Company of Spring, Tex., which material complies with specifications of recycle code “5”. In yet another embodiment, the bulb 104 is made of a thermoplastic polyolefin (TPO), which material complies with specifications of recycle code “5”. In still another embodiment, the bulb 104 is made of a thermoplastic elastomer (TPE), which material complies with specifications of recycle code “5”. In a further embodiment, the bulb 104 is made of a thermoplastic olefin elastomer (TPE-O), which material complies with specifications of recycle code “5”.

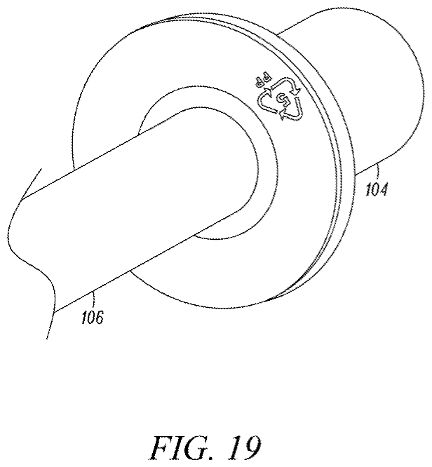

In each of the aforementioned embodiments, the bulb 104 complies with specifications of recycle code “5”. In some embodiments, the bulb 104 includes a recycle code symbol (see FIG. 19) of recycle code “5”.

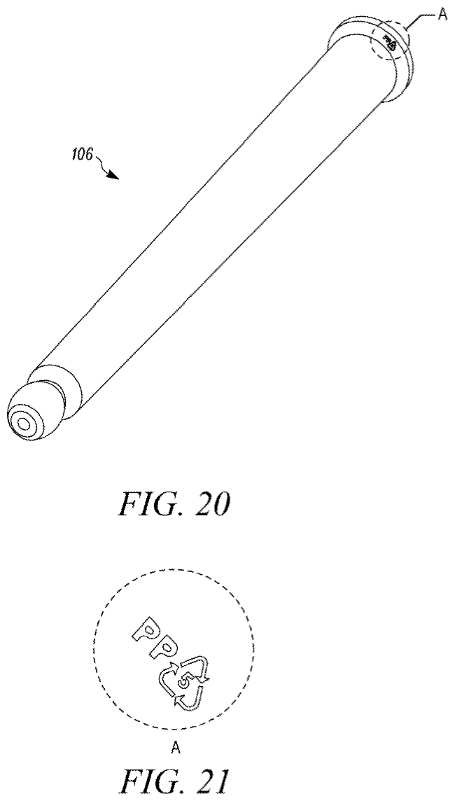

In one embodiment, the pipette 106 is made of standard clarified polypropylene with a clarifying agent 1,2,3-trideoxy-4,6:5,7-bis-O-((4-propylphenyl)methylene)-nonitol manufactured by Milliken & Company of Spartanburg, S.C. and marketed under the tradename NX® UltraClear™. The clarifying agent 1,2,3-trideoxy-4,6:5,7-bis-04(4-propylphenyl)methylene)-nonitol is marketed under the tradename Millad® NX® 8000 by Milliken & Company. NX® UltraClear™ brand polypropylene is a master batch that can be let down at a specified ratio or can be purchased as a polypropylene with Millad® NX® 8000 brand clarifying agent integrated into the polymer to eliminate a need for weighing and mixing every batch. Advantageously, a pipette made of NX® UltraClear™ brand polypropylene can be as clear as polyethylene terephthalate, reduces the hazy white effect of standard clarified polypropylene by up to 60% and is recyclable. Consequently, an amount of liquid, or bulk, in the pipette 106 can be readily discerned. Polyethylene terephthalate does not comply with specifications of recycle code “5”. Advantageously, the pipette 106 does not break or shatter as easily as a glass pipette. Unlike a pipette made of glass, the pipette 106 would bend, not break. The pipette 106 complies with specifications of recycle code “5”. In one embodiment, the pipette 106 includes a recycle code symbol (see FIG. 20) of recycle code “5”. In one embodiment, the pipette 106 includes a pigment that causes the pipette to have a color while remaining transparent. Advantageously, the pipette 106 with the pigment retains its compliance with the specifications of recycle code “5”.

In one embodiment, the cap 108 is made of polypropylene. The cap 108 complies with specifications of recycle code “5”. In one embodiment, the cap 108 includes a recycle code symbol (see FIG. 21) of recycle code “5”. In one embodiment, the cap 108 is made from polypropylene which can be made at varying levels of post-consumer recycled polypropylene. In one embodiment, the cap 108 is made of an injection grade polypropylene. Advantageously, the recycle code of the cap 108 is the same as the recycle code of the bulb and the pipette.

A purpose of the dropper 102 is to increase sustainability of packages in the cosmetic industry. Advantageously, the material of the bulb 104, the material of the pipette 106 and the material of the cap 108 give the proper protection for beauty industry chemicals that are used, such as retinol, volatile silicones and sun protection factor (SPF) chemicals. Other thermoplastic elastomers such as styrene block copolymers that are used with known droppers do not hold up to retinol, volatile silicones and SPF chemicals.

FIG. 2 is a top view of the dropper 102.

FIG. 3 is a bottom view of the dropper 102.

FIG. 4 is a cross-sectional view of the dropper 102.

In one embodiment, the length 110 of the dropper 102 is greater than 3 inches, and with the largest dimension of the bulb 104, the pipette 106 and the cap 108 less than 2 inches individually. However, the fact that the largest dimension of each of the bulb 104, the pipette 106 and the cap 108 is less than 2 inches individually is not critical because, in accordance with the invention, the dropper 102 is recyclable as a single unit, i.e., without being disassembled into its parts.

In another embodiment, the length 110 of the dropper 102 is 2.89 inches, which is 73.58 mm. In such embodiment, the largest dimension of the bulb 104 is 25.75 mm, the largest dimension of the pipette 106 is 25.75 mm, and the largest dimension of the cap 108 is 22.30 mm. However, in such embodiment, the dimensions of the bulb 104, the pipette 106 and the cap 108 are not critical because, in accordance with the invention, the dropper 102 is recyclable as a single unit, i.e., without being disassembled into its parts.

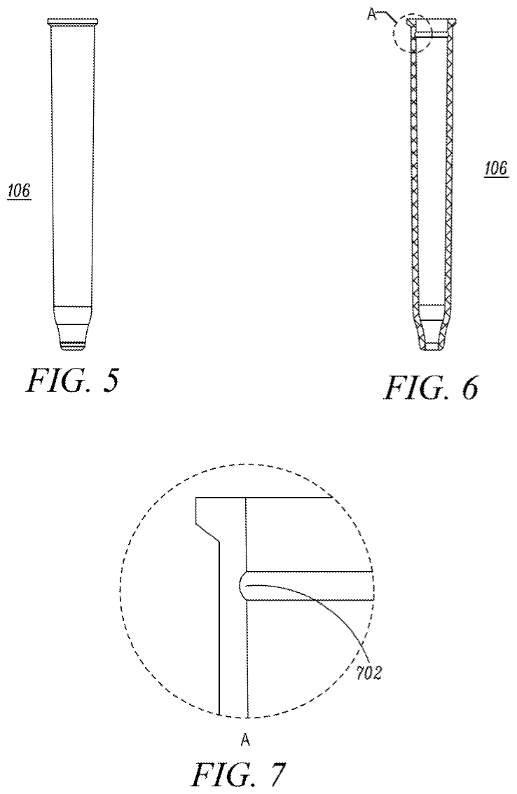

FIG. 5 is a front view of the pipette 106.

FIG. 6 is a cross-sectional view of the pipette 106.

FIG. 7 is an enlargement of area “A” shown in FIG. 6, including an undercut 702 on an inside of the pipette 106 nearest the bulb 104 when assembled. Because the pipette 106 is for the beauty industry and clarity is important, in addition to using NX® UltraClear™ polypropylene, a cavity and core of a steel mold of a plastic injection molding tool is polished to an A1 level, or a mirror, polish. This enhances the clarity of the resin after molding, but creates a problem of ejecting the pipette 106 out of the cavity when the mold opens. This problem arises due to the draw required when extracting the pipette 106 from the cavity. This problem occurs when two halves of the mold separate with a desired effect of the pipette 106 to stay on the core and not remain in the cavity. The high level of polish does not assist in extracting the pipette 106 from the cavity but helps the pipette stay in the cavity due vacuum and adhesion of the surfaces. An amount of area in the cavity is far greater than an amount of area on the core which can counter the extraction of the pipette from the cavity. The undercut on the core aids in the removal of the pipette 106 from the cavity by providing a force that overcomes the force wanting to keep the pipette in the cavity. The undercut allows for the extraction of the pipette 106 from the cavity while not damaging inner surfaces of the pipette when the pipette is ejected off the core. Both halves of the mold have one of the highest levels of polishing which causes the pipette 106 to slip off the core and stay in the mold when the mold opens and two halves of the mold separate. Advantageously, the undercut 702 holds the pipette 106 on the core but still allows the pipette to be ejected cleanly. With plastic injection molding, the undercut 702 must be done correctly or else, when the pipette 106 is ejected from the mold, the mold will tear the undercut or smear the pipette. In one embodiment, the undercut 702 is parallel to an end of the pipette 106 nearest the bulb 104 when assembled. In one embodiment, the undercut 702 has a width of approximately 0.82 mm and a centerline of the undercut is approximately 2.63 mm from the end of the pipette 106 nearest the bulb 104 when assembled. In another embodiment (not shown), instead of the undercut 702, the pipette 106 has a protrusion (not shown) at the same location and approximately the same width.

Advantageously, all components of the dropper 102 are made of materials that comply with recycle code “5” specification.

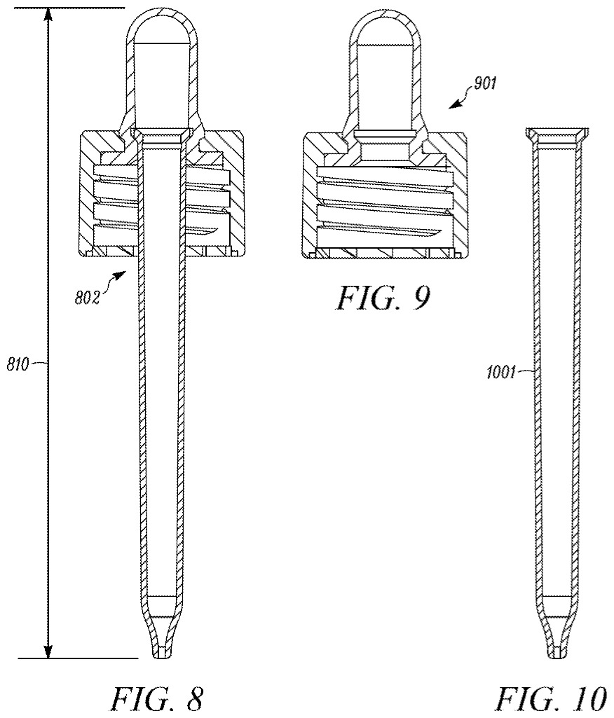

FIG. 8 is a front view of a two-piece dropper 802 in accordance with the invention. The two-piece dropper 802 comprises a combined bulb and cap 901 (see FIG. 9) and a pipette 1001 (see FIG. 10) coupled to the combined bulb and cap. Although a size of the combined bulb and cap 901 and the pipette 1001 may be less than 2 inches individually, the two-piece dropper 802 advantageously has a length 810 of at least 2 inches. Therefore, the two-piece dropper 802 meets the minimum-size requirement for recyclability. The two-piece dropper 802 is recyclable as a unit, i.e., the two-piece dropper can be recycled without first being disassembled. In one embodiment, the two-piece dropper 802 attaches to a container or bottle 2400 in a manner well known. The bottle 2400 may hold a liquid, or bulk, that can be pulled into the pipette 1001 and dispensed from the pipette through use of the two-piece dropper 802 in a manner well known. Advantageously, all components of the two-piece dropper 802 are made of materials that comply with recycle code “5” specifications.

The two-piece dropper 802 has several advantages over a three-piece dropper. The two-piece dropper 802 removes one assembly step normally required with a three-piece dropper. A three-piece dropper requires that the bulb be first inserted into the cap, either from the top opening or the bottom opening, and be seated in place. The three-piece dropper requires that the pipette be inserted into the sub-assembly consisting of the separate cap and bulb from the bottom side of the cap and seated into place with the bulb. Advantageously, the two-piece dropper 802 only requires the pipette 106 be seated into the combined bulb and cap 901.

The bulb portion of the combined bulb and cap 901 is made from one of: polyolefins with alternating blocks of hard and soft segments, an ethylene propylene copolymer, a thermoplastic polyolefin, a thermoplastic elastomer, and a thermoplastic olefin elastomer. The cap portion of combined bulb and cap 901 is made from polypropylene. The two portions when molded via two-shot molding or transfer molding chemically bond because they are the same family of materials. As a result, the two portions fuse together to become a single piece. The material of the bulb portion is miscible in polypropylene and in polyethylene. The materials of the two portions of the combined bulb and cap 901 chemically bond and mechanical lock together, thus a single part made from two materials. The combined bulb and cap 901 has several advantages over a separate bulb and cap besides the elimination of one assembly step. Advantageously, a seal that is created between the cap portion and a flange of the bulb portion is one piece thus eliminating a path for liquid or gas to escape when the dropper is used in conjunction with a container containing a bulk or liquid. Another advantage of the combined bulb and cap 901 is that the flange of the bulb portion is an integral part of the cap portion thus allowing for better sealing through torque applied when closing. The bulb portion cannot twist, turn or rotate when being applied to a container. This allows for a more competent sealing with bulks or liquids that may out gas when under different but common conditions, such as room temperature versus transit temperature.

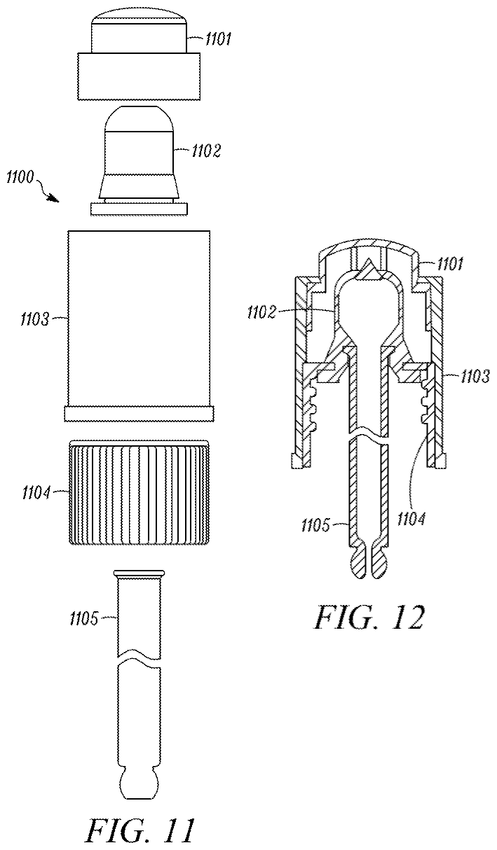

FIG. 11 is an exploded view of a push-button dropper 1102 in accordance with one embodiment of the invention. The push-button dropper 1102 includes a button 1101, a bulb 1102, a collar 1103, a cap 1104 and a pipette 1105. FIG. 12 is a cross-sectional view of the push-button dropper 1102. The button is coupled to the bulb such that depressing the button squeezes the bulb. When coupled to a bottle containing bulk or liquid, the push-button dropper 1102 gives a user an ability to push the button 1101 to draw a dose and dispense a dose. Known buttons and collars are made from acrylonitrile butadiene styrene, styrene acrylonitrile resin or acrylonitrile styrene, each of which falls under recycle code “7”. Advantageously, all components of the push-button dropper 1102 are made of materials that comply with recycle code “5” specifications. Known push-button droppers use amorphous thermoplastic resins used in their outer collar. Amorphous thermoplastic resins used in known push-button droppers typically shrink equally in all directions. On the other hand, the collar 1103 of the push-button dropper 1102 is made of polypropylene. In one embodiment (not shown) the collar 1103 includes a recycle code symbol. A thickness of intersecting walls of the collar 1103 of the push-button dropper 1102 is 50% of a thickness of an outside facing wall. This is required because, unlike the amorphous thermoplastic resins used in known push-button droppers, polypropylene is a semi-crystalline thermoplastic. Semi-crystalline materials exhibit much higher shrink rates as well as can have a different shrink rate when compared to flow versus cross flow direction. Due to this phenomenon with polypropylene, sink can occur in outward facing walls unless the intersecting walls of the collar 1103 of the push-button dropper 1102 are 50% of the outside facing wall.

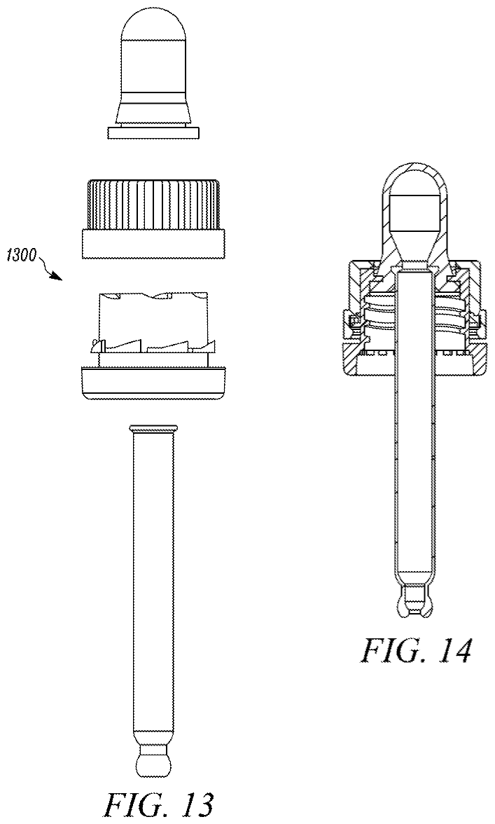

FIG. 13 is an exploded front view of a child resistant closure dropper 1300 in accordance with the invention. Advantageously, all components of the child resistant closure dropper 1300 are made of materials that comply with recycle code “5” specifications.

FIG. 14 is a cross-sectional view of the child resistant closure dropper 1300.

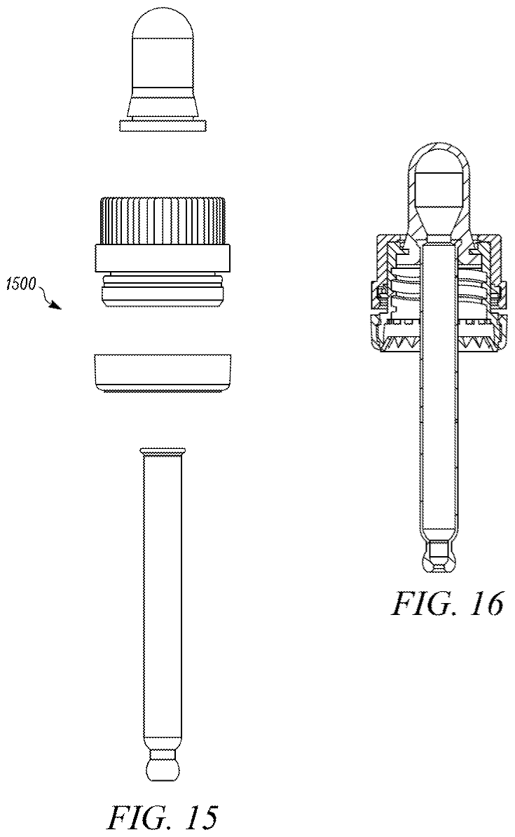

FIG. 15 is an exploded front view of a tamper evident dropper 1500 in accordance with the invention. Advantageously, all components of the tamper evident dropper 1500 are made of materials that comply with recycle code “5” specifications.

FIG. 16 is a cross-sectional view of the tamper evident dropper 1500.

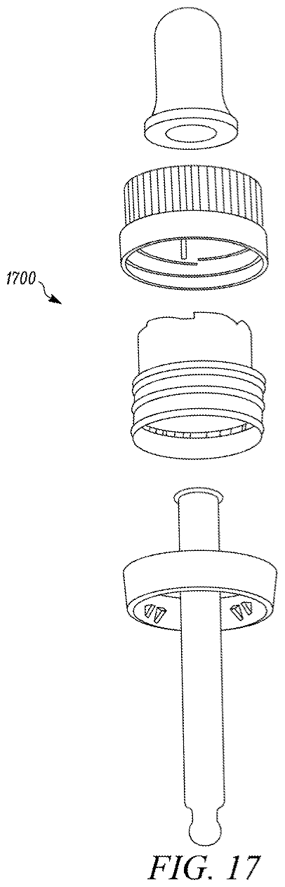

FIG. 17 is an exploded view of a child resistant-tamper evident dropper 1700 in accordance with the invention. Advantageously, all components of the child resistant-tamper evident dropper 1700 are made of materials that comply with recycle code “5” specification.

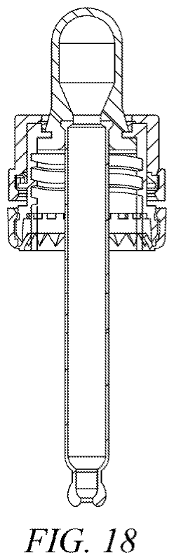

FIG. 18 is a cross-sectional view of the child resistant-tamper evident dropper 1700. The child resistant-tamper evident dropper 1700 is similar to the child resistant closure dropper 1300 with an addition of a tamper-evident ring at the bottom.

FIG. 19 is a perspective view of the bulb 104 and part of the pipette 106 showing a recycle code symbol on the bulb. The bulb 104 includes the recycle code symbol for recycle code “5”.

FIG. 20 is a perspective view of the pipette 106 showing a recycle code symbol on the pipette.

FIG. 21 shows detail of area “A” in FIG. 20. The pipette 106 includes the recycle code symbol for recycle code “5”.

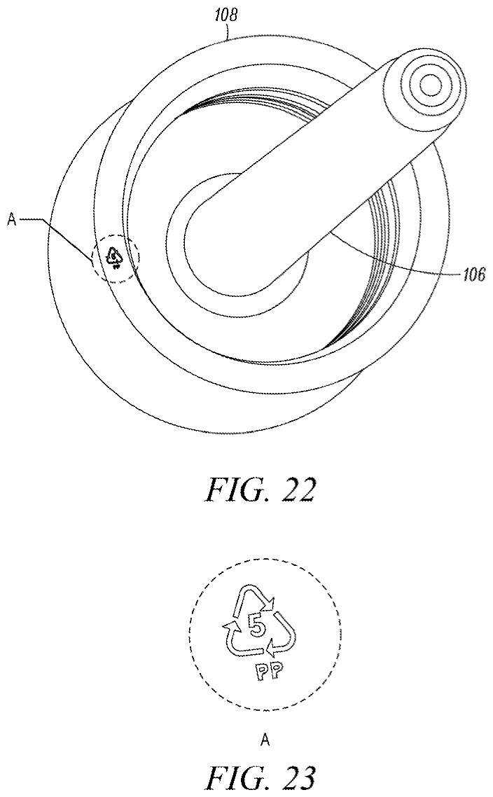

FIG. 22 is a perspective view of the pipette 106 and the cap 108 showing a recycle code symbol on the cap.

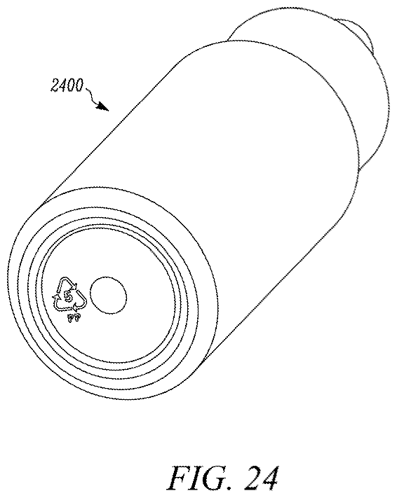

FIG. 23 shows detail of area “A” in FIG. 22. The cap 108 includes the recycle code symbol for recycle code “5”.

FIG. 24 is a perspective bottom view of a bottle 2400, which may be used with the dropper 102 and which shows a recycle code symbol on a bottom of the bottle. The bottle 2400 includes the recycle code symbol for recycle code “5”.

In one embodiment, the dropper 102 and 802 is an eye dropper.

The terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

The Detailed Description section, and not the Abstract section, is intended to be used to interpret the claims. The Abstract section may set forth one or more but not all embodiments of the invention, and the Abstract section is not intended to limit the invention or the claims in any way.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages or solutions to problems that are described herein with regard to specific embodiments are not intended to be construed as a critical, required, or essential feature or element of any or all the claims.

I claim:

1. A dropper, comprising:
a bulb composed entirely of one of:
an ethylene propylene copolymer,
a thermoplastic polyolefin,
a thermoplastic elastomer, and
a thermoplastic olefin elastomer;
a pipette composed entirely of recyclable material that complies with recycle code “5” specifications, the pipette coupled to the bulb; and
a cap composed entirely of recyclable material that complies with recycle code “5” specifications, the cap coupled to the bulb.

2. The dropper of claim 1, wherein bulb is composed entirely of recyclable material that complies with recycle code of “5” specifications.

3. The dropper of claim 1, wherein the pipette is made of standard clarified polypropylene with clarifying agent 1,2,3-trideoxy-4,6:5,7-bis-O-((4-propylphenyl)methylene)-nonitol.

4. The dropper of claim 1, wherein the cap is made of polypropylene.

5. The dropper of claim 1, wherein the pipette includes an undercut on an inside of the pipette nearest the bulb.

6. The dropper of claim 1, wherein the bulb, the pipette and the cap each include a cycle code symbol.

7. The dropper of claim 1, wherein a length of the dropper is greater than 2 inches.

8. The dropper of claim 7, wherein the dropper is recyclable as a single unit.

9. A two-piece dropper, comprising:
a combined bulb and cap composed entirely of recyclable material that complies with recycle code of “5” specifications; and
a pipette composed entirely of recyclable material that complies with recycle code of “5” specifications, the pipette coupled to the combined bulb and cap.

10. The two-piece dropper of claim 9, wherein the combined bulb and cap consists of a bulb portion and a cap portion, wherein bulb portion and the cap portion are fused together to become a single piece.

11. The two-piece dropper of claim 10, wherein the bulb portion is made of one of:
polyolefins with alternating blocks of hard and soft segments,
an ethylene propylene copolymer,
a thermoplastic polyolefin,
a thermoplastic elastomer, and
a thermoplastic olefin elastomer.

12. The two-piece dropper of claim 10, wherein the cap portion is made of polypropylene.

13. The two-piece dropper of claim 9, wherein the pipette is made of standard clarified polypropylene with clarifying agent 1,2,3-trideoxy-4,6:5,7-bis-O-((4-propylphenyl)methylene)-nonitol.

14. The two-piece dropper of claim 9, wherein the pipette includes an undercut on an inside of the pipette nearest the combined bulb and cap.

15. The two-piece dropper of claim 9, wherein the two-piece dropper is recyclable as a single unit.

16. The two-piece dropper of claim 9, wherein the combined bulb and cap includes a cycle code symbol, and wherein the pipette includes a cycle code symbol.

17. A push-button dropper comprising:
a button composed entirely of recyclable material that complies with recycle code of “5” specifications;
a bulb composed entirely of recyclable material that complies with recycle code of “5” specifications, the bulb coupled to the button such that depressing the button squeezes the bulb;
a collar composed entirely of recyclable material that complies with recycle code of “5” specifications, the collar surrounding the bulb;
a cap composed entirely of recyclable material that complies with recycle code of “5” specifications, the cap coupled to the collar; and
a pipette composed entirely of recyclable material that complies with recycle code of “5” specifications, the pipette coupled to the bulb.

18. The push-button dropper of claim 17, wherein the pipette includes an undercut on an inside of the pipette nearest the bulb.

19. The push-button dropper of claim 17, including a bottle, wherein the bulb, the collar, the cap, the pipette and the bottle each include a recycle symbol.

20. The push-button dropper of claim 19, wherein the push-button dropper and the bottle are recyclable as a single unit.
